(19) United States
(12) Patent Application Publication
(10) Pub. No.: US 2006/0161315 A1
(43) Pub. Date: Jul. 20, 2006

(54) Vehicle position and performance tracking system using wireless communication

(76) Inventors: Ron Lewis, Mississippi State, MS (US); Joe Picone, Starkville, MS (US); Zach Rowland, Starkville, MS (US); Will Jenkins, Starkville, MS (US); Georgios Lazarou, Starkville, MS (US)

Correspondence Address: Patent Group;DLA PIPER RUDNICK GRAY CARY US LLP, 1200 Nineteenth Street, N.W., Washington, DC, 20036-2412, US

(21) Appl. No.: 11/283,913

(22) Filed: Nov. 22, 2005

Related U.S. Application Data
(60) Provisional application No. 60/629,552, filed on Nov. 22, 2004.

(51) Int. Cl. G06F 17/00

(52) U.S. Cl. 701/1; 701/29

(57) ABSTRACT

A real time vehicle communications system comprises an interface unit configured to communicate with an onboard vehicle performance system and an onboard vehicle positioning system; a processor unit connected to the interface unit; a memory unit connected to the processor unit; a communications unit connected to the processor unit, the communications unit being configured for wireless communication. The processor unit is configured to store data from the vehicle positioning system and the vehicle performance system in the memory unit, and transmit at least some information from the memory unit, via the communications unit, to one or more peer vehicles outside the vehicle under the direction of a user; and one or more base stations outside the vehicle.

### RELATED APPLICATIONS

This application is based on U.S. Provisional Application Ser. No. 60/629,552, filed Nov. 22, 2004, the entire contents of which are hereby incorporated by reference.

### BACKGROUND

### Field

One embodiment of the present invention relates to a transportation system that integrates vehicle position and performance tracking and wireless networking to monitor vehicle position and performance over the Internet.

### DESCRIPTION OF THE FIGURES

FIG. 1 is a block diagram of one embodiment of the VPPTS 100.

FIG. 2 is a block diagram one embodiment of a vehicle communicator system.

FIG. 3 is a schematic diagram of one embodiment of a BR-3 interface used to communicate with a vehicle's on-board diagnostic system.

FIG. 4 is a block diagram of one embodiment a data collector, which polls a vehicle for performance information and receives new GPS coordinates simultaneously.

FIG. 5 is a data flow to the users applet interface after being processed by the server.

FIG. 6 shows one embodiment of an analog gauge applet that displays real-time performance parameters.

FIG. 7 shows one embodiment of communication architecture that allows a web-enabled application to monitor various sensors in a vehicle across the GSM/GPRS network.

### DETAILED DESCRIPTION OF SEVERAL EMBODIMENTS

Real-time vehicle tracking and monitoring is evolving from simple systems such as OnStar™ to more sophisticated systems that provide emergency response capabilities. The present inventors have found that providing access to vehicle data via the Internet can lead to intelligent mass transportation and secure fleet management. Some embodiments of the vehicle position and performance tracking system (VPPTS 100) described herein include three underlying technologies: GPS, GSM/GPRS, and OBD-II.

This system is based in-part on a popular standard for wireless communications—GSM/GPRS (2). An in-vehicle standard for diagnostic information, OBD-II (3), is used to gather performance data. GPS technology (4) is also used to provide vehicle location data. Data is integrated and transmitted to a web server using Apache's Tomcat extension (5) to provide Internet access via a vehicle tracking web site.

One embodiment of the present intelligent transportation system (ITS) includes several vehicle communication systems including peer-to-peer (P2P) and peer-to-base station communications. Seamless integration of in-vehicle networking with existing wireless telephony infrastructure is possible. Drivers may roam between their cellular phone network and their in-vehicle network. Data access and synchronization happen automatically and transparently. Peer-to-peer communications provides an ability for information to be relayed down a highway so that a transportation system can adapt and respond to events autonomously in real-time.

The present system is extensible to large metropolitan areas in which millions of vehicles will need to be simultaneously tracked and monitored. Though many systems currently integrate position tracking and wireless networking to allow for remote position tracking, few systems prove the capability to monitor vehicle performance over the web in real-time as the present system allows.

One embodiment of the present system is suitable for dealing with roadside emergencies, providing homeland security solutions, fleet operators accounting for the location and contents of their vehicles, first responders in emergencies such as hazardous material spills or natural disasters, rapidly delivering information about vehicle content and location, as well as real-time mapping information, exploiting next generation wireless technology, delivering bidirectional high-speed data connections to moving vehicles, data warehousing, monitoring transportation infrastructure, commercial and personal applications, and vehicle location tracking.

Some embodiments of the VPPTS 100 described herein utilizes three underlying technologies: GPS, GSM/GPRS, and OBD-II. GPS provides highly accurate position information and can be used for a variety of land, sea, and air applications. GPS was developed by the U.S. Department of Defense (DoD). The system includes a constellation of 24 geostationary satellites orbiting around 11,000 miles above the Earth's surface (9). GPS was dedicated solely for military use and has recently been declassified for civilian use. To acquire GPS information, a wireless receiver capable of the civilian L1 frequency (1575.42 MHz) is included. The GPS receiver measures distances to four or more satellites simultaneously. Using triangulation (9) the receiver can determine its latitude, longitude, and altitude.

GSM has become the world's fastest growing mobile communication standard. It allows for seamless and secure connectivity between networks on a global scale. Digital encoding is used for voice communication, and time division multiple access (TDMA) transmission methods provide a very efficient data rate/information content ratio (10). GSM, a circuit-switched network, is becoming the standard for person-to-person communication. In view of improved data transmission, General Packet Radio Service (GPRS), may also be used.

GPRS is a data communication layer built over the GSM wireless transmission link (2). GPRS uses the remaining capacity leftover from GSM voice communication (11) and has a theoretical max speed of 171.2 Kbps making it a viable choice for wireless data transfer (10). Using a packet format for data transmission allows for full compatibility with existing Internet services such as HTTP, FTP, email, instant messaging, and more.

Since 1996, on-board diagnostic (OBD) systems have been incorporated into vehicles to help manufactures meet emission standards set forth by the Clean Air Act in 1990 and the Environmental Protection Agency (EPA). The Society of Automotive Engineers (SAE) developed a set of standards and practices that regulated the development of these diagnostic systems. The SAE expanded on that set to create the OBD-II standards. The EPA and the California Air Resources Board (CARB) adopted these standards in 1996 and mandated their installation in all light-duty vehicles.

The OBD-II system allows for monitoring of most electrical systems on the vehicle. Nonlimiting examples of monitored items include speed, RPM, ignition voltage, oil temperature, oil pressure, tire pressure, vehicle integrity, and coolant temperature. This system can also inform an engineer when an individual cylinder has a misfire.

The SAE recognizes three communication patterns, or protocols, in the J1850 standard, which define how electrical signals will propagate through a vehicles communication bus. These are described in Table 1 below.

TABLE 1

| Protocols | Signal Type | Manufacturer |
|---|---|---|
| SAE J1850 | Variable Pulse | GM |
| VPW | Width | |
| SAE J1850 | Pulse Width | Ford |
| PWM | Modulation | |
| ISO 9141-2 | Two Serial Lines: | European, Asia, |
| | Half-duplex (L) | and Chrysler |
| | Full-duplex (K) | |

The SAE J1850 VPW standard uses a variable pulse width modulation signal (12). It operates at 10.4 k Baud with one signal wire and a ground wire. The SAE J1850 PWM standard uses a pulse width modulation signal (12). This operates at 41.7 k Baud by using a differential transmission scheme. The ISO 9141-2 standard uses two signals (K and L) (12). One signal travels on a full-duplex wire, and the other operates on a half-duplex wire. Most communications with the OBD-II bus occur on the K signal while the L signal is required for initialization of the bus.

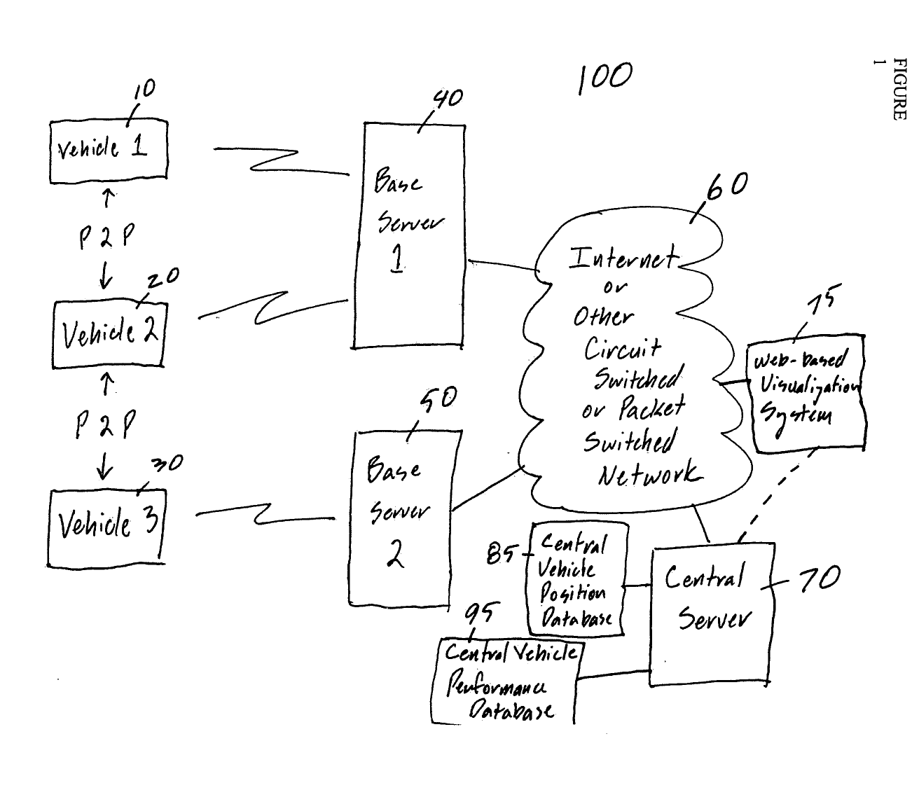

FIG. 1 shows an overview of one embodiment of the VPPTS 100. Vehicles 10, 20, 30 may wirelessly communicate with each other using P2P, or wirelessly communicate with one or more base servers 40, 50. The base servers 40, 50 may communicate physically or wirelessly to another base server or physically or wirelessly to the Internet or any other network, such as a circuit switched or packet switched network. The base servers 40, 50 may communicate through the Internet or other network with one or more central server 70.

In one embodiment, a real time vehicle performance and position monitoring system is provided that comprises at least one wireless networking module including:

a GPS receiver to collect position data of a vehicle;

a graphical user interface which communicates with a microchip onboard the vehicle and one or more off site computers/servers located at one or more data collection sites;

data collector software, which collects position data from the GPS receiver and onboard diagnostic data from a microcontroller; and

a wireless computer card in communication with the microchip, which accesses a wireless network and relays position data and diagnostic data to the off site computers/servers.

In one embodiment, the off site computers/servers include cell phone, PDAs and other networking devices.

One embodiment of a real-time vehicle tracking and performance monitoring system includes:

at least one vehicle communicator system unit;

at least one vehicle location and performance database; and

at least one web-based data visualization system 75.

In one embodiment, the vehicle communications system 200 may be comprised of the following:

an input/output (I/O) subsystem or unit 210;

a power management subsystem or unit 220;

a communication subsystem or unit 230;

communicator software; and

a processor subsystem or unit 240.

In one embodiment, the input/output (I/O) subsystem 210 collects vehicle GPS and performance data as well as external, “non-networked” sensor data (sensors installed on the vehicle but not connected to vehicle network).

In one embodiment, the power management subsystem 220 includes integrated circuitry that monitors vehicle power and controls active/sleep/shutdown modes.

In one embodiment, the communication subsystem 230 establishes and maintains physical connections to the vehicle location and performance database for transmission of the data via various wireless communication networks.

In one embodiment, the communication subsystem 230 is capable of vehicle-to-vehicle (peer-to-peer) communication for relaying any data including vehicle location and performance data or Intelligent Transportation System (ITS) data; and/or exchanging personal (driver or vehicle), ITS, or Internet (restaurant location) data.

In one embodiment, the communicator software collects and formats data for transmission into single or multiple data streams.

In one embodiment, the processor subsystem 240 runs real-time operating system that manages data collection and communications.

In one embodiment, the vehicle location and performance database is comprised of at lease one communication server and at least one database server. The communication server may provide secure connectivity to the vehicle communicator system. The communication server formats the received data and relays it to one or more database servers. The database server may store received data into one or more databases.

One embodiment of a web-based data visualization system may include a graphical user interface (GUI) and at least one database server. The graphical user interface may display vehicle location on a highly interactive GIS-based map and/or process and display data in various forms including playback functionality and real-time dashboard gauges. The database server may retrieve data from one or more databases and forward it to the GUI.

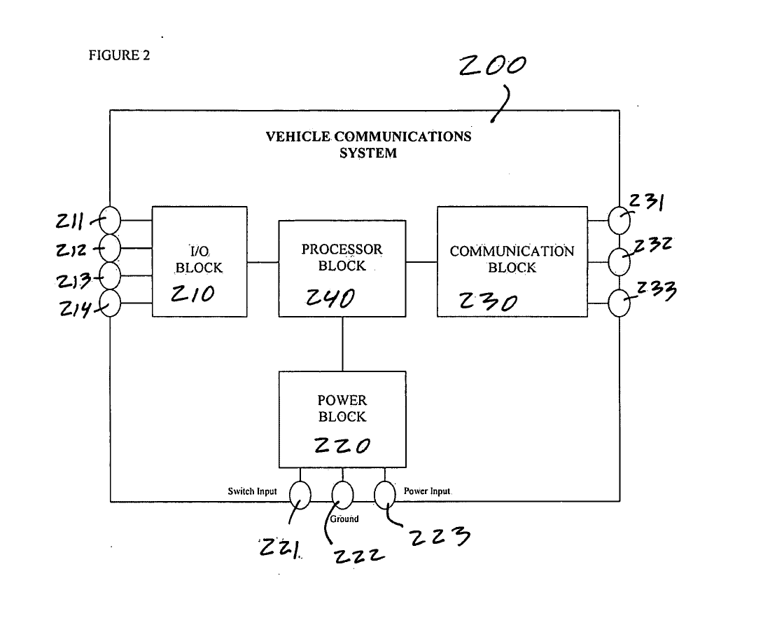

One embodiment of a vehicle communicator system is illustrated in FIG. 2. It may include an input/output (I/O) system 210; power management subsystem 220; communication subsystem 230; communicator software; processor subsystem 240.

The input/output (I/O) subsystem 210 may include one or more of the following components:
an SAE J1850 transceiver and controller including support for GM Class 2, Ford SCP, and ISO 9141-2;
a CAN/FlexRay transceiver and controller with SAE J1939 capabilities;
an SAE J1708 compatible transceiver and controller;
one or more programmable digital/analog inputs and outputs for “non-networked” sensors;
NMEA-0183 compatible GPS transceiver with external antenna interface;
a PC interface (USB/RS232) for on-site debugging; and/or
one or more visual indicators for operating modes and programmable fault conditions.

The power management subsystem 220 may include one or more of the following components:

an internally-fused power supply that can accept 12, 24, and/or 42 VDC inputs and other forms such as backup battery, solar power, etc; and/or
a controllable power monitoring circuitry.

The communication subsystem 230 may include one or more of the following components:
an integrated WiFi chipset and 3G or 4G cellular networking modem;
one or more universal sockets that supports the following:
   Mobile WiMax (IEEE 802.16e);
   any additional 3G or 4G modem; and/or software radio.
an interface for external satellite modem; and/or
an interface to external SISO, SIMO, and/or MIMO antennae.

The communicator software in the communication subsystem 230 may have one or more of the following specifications:
multi-threaded;
gather specified data into “circular buffer”;
format available data into “frames” for transmission; and/or forwards “frames” to communication subsystem 230.

The processor subsystem 240 must have an operating system and a communication protocol stack and may have one or more of the following specifications:
supports a variety of real-time operating systems (RTOS) such as embedded Linux, Windows CE, and VxWorks;
communication protocol stack that includes mobile IPv6 and custom-built, robust, and network-aware transport protocol; and/or
data reduction and intelligent signal processing for collaborative decision-making network.

In embodiments employing a mobile IPv6 communications standard, each vehicle is assigned its own IP address. This facilitates direct P2P communications. In such embodiments, a first vehicle may periodically broadcast a message (when a user in such vehicle so desires) announcing its presence. When a second vehicle in communications range receives such a message, the user in the second vehicle can decide whether or not to establish P2P communications with the first vehicle. If the user indicates to the vehicle communications system in the second vehicle that P2P communications are desired, the vehicle communications system in the second vehicle responds to the message from the first vehicle to initiate the P2P communications process. Those of skill in the art will recognize that alternative techniques for establishing P2P communications may also be employed.

One embodiment of a vehicle location and performance database includes at least one communication server and at least one database server. The server may be a central server or a base server. One embodiment of a communication server includes any server that accepts client/server paradigm; and decodes received data, format to database specifications, and forwards to database server. Any database server may be used.

One embodiment of a web-based data visualization system includes a graphical user interface and a database server.

One embodiment of a graphical user interface includes one or more of the following functions and components:

capability to generate a map based on GIS data based on user input using the client/server paradigm (e.g., maps are generated by the server and sent to the client);

capability to translate vehicle GPS coordinates to pixel locations and display on the map;

an integrated software component configured to prepare data for external uses such as spreadsheets and other data analyzing software;

an integrated software component to allow a user to “playback” historical data; and/or

an integrated software component to allow a user to view real-time performance data with dashboard gauges.

In FIG. 2, one embodiment of the vehicle communicator system is shown. In the figure, circles are described on the outer perimeter of the drawing (the outer perimeter figuratively symbolizing a box or case that contains the blocks and the circles figuratively symbolize the various interfaces by which data, electrical signals, power, grounding, and the like are passed). The circles 211-214 on the left side of the drawing connected to the “I/O Block” 210 represent various inputs and outputs. These may include, for example, one or more of OBD-II data, video and/or camera data, audio data, vehicle data, position data, operator voice data, and the like, or any combination thereof. The circles 231-235 on the right side of the drawing represent various communication signals such as, for example, to and from one or more other vehicles, to and from one or more database servers, to and from one or more central servers 70. The circles 221-223 at the bottom of the figure may represent various power and switching sources and/or controls.

One embodiment includes a single-board that integrates modular chipset solutions for the automotive bus interface, a GPS receiver, and a GSM/GPRS modem into a less than 16 in 2 board located inside the dashboard or in the trunk of a vehicle. The system may be powered directly off the on-board diagnostic connector that includes 12V power. External antennae may be added to increase the reliability of GSM and GPS reception. Tracking more parameters and adding feedback features such as peer-to-peer communications may further increase the system effectiveness. Integration of Bluetooth and IEEE 802.11 b wireless (WiFi) technology may be utilized in view of eliminating the cost and labor of point-to-point wiring within the vehicle.

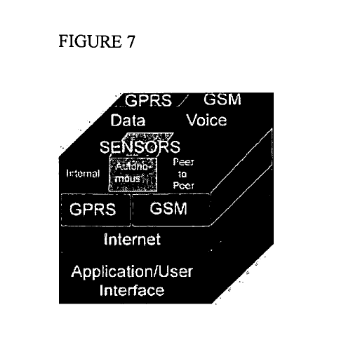

FIG. 7 shows one embodiment of the system communication architecture. This communication architecture allows a web-enabled application to monitor various sensors in a vehicle across the GSM/GPRS network. The present design incorporates both light-duty and heavy duty communication protocols. The SAE standards J1708 (16) and J1939 (17) describe examples of heavy-duty protocols and parameters. J1939 describes the next generation of heavy duty vehicle network based on controller area network (CAN) (18). Heavy-duty vehicles include, but are not limited to, semi-trucks and buses.

The database can be extended to include cargo contents, driver identification, and named-based location data such as cities, street names, and businesses. One embodiment of the present system incorporates Geographic Information System (GIS) (19) data, which allows for faster response times in map drawing for applications involving emergency response to hazardous material spills, vehicular accident, etc. GIS is a standard digital mapping format that uses GPS coordinates. GIS allows the final design to be scalable to wider areas such as citywide, statewide, and even nationwide.

Many systems offer vehicle security and tracking. Systems such as Trackn, OnStar, and TrimTrac offer remote lock mechanisms and roadside assistance. Subscription services are required for these systems. The present system offers vehicle tracking using a well-established GSM/GPRS network and also offers performance tracking for the host vehicle, which can be monitored over the web.

Timing is one important consideration in the system. A system timer may be used to trigger an event to send the GPS and current OBD-II data. The intervals conceived were between ¼ and 5 seconds. This small resolution could not be achieved because polling at least 6 PIDs took longer than ¼ seconds. To keep an accurate resolution, the GPS signal may be used as an event trigger, in view of keeping the resolution at multiples of one second.

In one embodiment, a GIS relational database of a geographic region is integrated into the system using technology based on ESRI's ArcGIS (19). This will reduce the amount of data that must be downloaded to the client, and vastly increase the ability to interact with maps. The present system can integrate with or utilize digital maps, such as a statewide map (20). One embodiment may interact with digital map information and produce value-added features such as information queries (e.g., “What is the closest fast-food restaurant to the bus stop?). In one embodiment, the system can work on low bandwidth devices with small displays, such as cell phones and PDAs.

In one embodiment, the system includes seamless in-vehicle communications with existing wireless devices, as well as an ability for vehicles, such as buses, for example, to interact in a peer-to-peer manner. This will support other vehicle communication protocols such as the SAE J1708 and J1939 communication standards for heavy-duty vehicles (e.g., passenger buses and semi-trucks).

As to priority of broadcast, the “camera” or transmitting vehicle may either manually intervene to determine a particular destination for the message packet (such as to other vehicles in the vicinity of an accident or road condition), or this may be determined automatically, wherein the video data from the camera vehicle is broadcast to all linked vehicles, and the receiving vehicles may determine what is displayed. Alternatively, the priority of broadcast is determined remotely, such as from the base station or central server 70. Combinations of these are possible.

The message packet may have one or more headers with one or more fields. If no destination is inputted, then a broadcast is effected, wherein the entire fleet may receive the message. Alternatively, if a destination appears in the field, the message will be received only by that destination. Alternatively, a broad I/O is contemplated which will accept a broad range of throughputs.

### EXAMPLES

A VPPTS 100 prototype was assembled and successfully operated as follows. A Garmin GPS 35-PC receiver is used to collect the recommended minimum data sentence (GPRMC) from the NMEA standard protocol (15). OBD-II data is gathered by a BR-3 interface. The interface incorporates a Microchip BR16F84-1.07 microcontroller, which operates on all SAE J1850 protocols. A Sony Ericsson GC-82 EDGE PC card is used to access the Cingular Wireless GSM/GPRS network. A laptop, equipped with two serial ports (DB9) and a PCMCIA port, acts as a hub through which data is routed.

The data collection software was developed with Microsoft C# using a Visual Basic 6 serial port API. Tomcat web server together with MySQL database server act as the gateway for users to view the location and performance data of each vehicle. The user interface was developed with JAVA SDK 1.4.2_{—}05.

The data collection software combines GPS coordinates and OBD-II data into a single data stream that is sent to the server via the GSM/GPRS network. The data is retrieved from the OBD-II system by continuous polling. Transmission of data to the server is triggered by a received event from the GPS device, which is connected to a serial port. This allows for a one second minimum resolution.

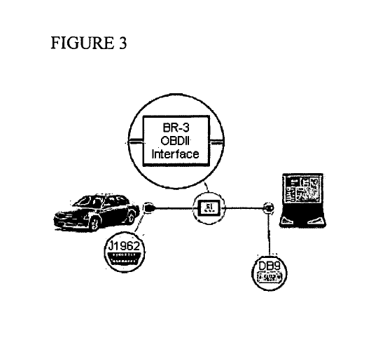

The BR-3 OBD-II interface is connected to the vehicle via the SAE J1962 (13) connector located within three feet of the steering column. A serial RS232 port on the laptop allows the data collector software to communicate with the BR-3 OBD-II interface. FIG. 3 shows the BR-3 connection diagram.

The baud rate between the BR-3 and the laptop is 19,200 Baud with no handshaking. A CRC byte, specified by SAE J1850 (12), is checked to confirm a successful transmission. All three protocols specified by SAE J1850 standard can be accessed with the BR-3. The VPPTS 100 prototype uses generic parameter identifications or PIDs defined in SAE J1979 (14). These PIDs include vehicle speed, engine RPM, calculated throttle position sensor (TPS), engine load, engine coolant temperature, and air intake pressure. Car manufacturers such as GM and Ford have enhanced PIDs that are specialized for their vehicles.

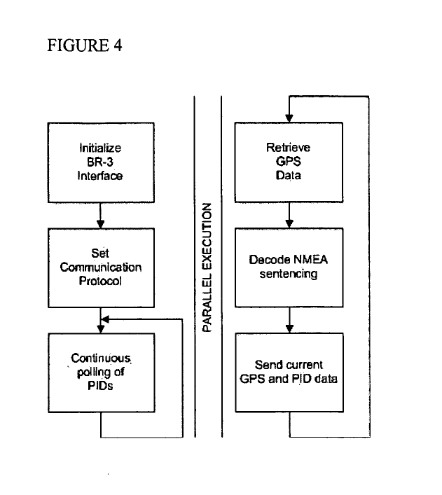

FIG. 4 illustrates a state diagram for the data collector. The BR-3 must be initialized and, depending on the make of the vehicle, a proper protocol must be set. Once these are established polling for data will commence on a continuous basis. The GPS data is transmitted as character arrays known as sentences. These sentences correspond to the NMEA standard (15) for GPS data. The GPRMC sentence, which contains UTC time, UTC date, longitude, and latitude, is decoded. The software parses the sentence and prepares the GPS data along with the current OBD-II data. The data is then sent to the server via GSM/GPRS.

The server was built using a dual processor PC, which is used to run the necessary software for the prototype system. Tomcat, MySQL, and Apache constitute the software needed to run the data and the applet. Five Tomcat httpservlets are used to maintain the data flow. MySQL was chosen to be the database management service, and Apache handles all HTTP page and image requests.

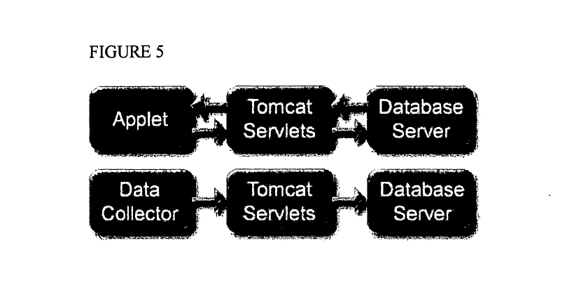

The httpservlets handle all the connections made to the database server (MySQL). There are two servlets that receive data from the collector through an http post. The data is then updated to the database. The other servlets make queries to the database package the data into specialized classes and send the classes to the applet when the data is requested. FIG. 5 shows the data flow to and from the server.

Several tables are used to maintain separation of data within the database. The stops table contains a label and GPS coordinates for each bus stop on all routes. The routes table contains a list of the routes and the order at which the stops are traversed. The buses table contains the current location and route information for each bus. The gauges database contains the telemetry data from each bus. There is also a table for each bus that contains all the past telemetry readings for that specific bus. This data can be stored indefinitely so it can serve as a tool for analysis and simulation of vehicle performance.

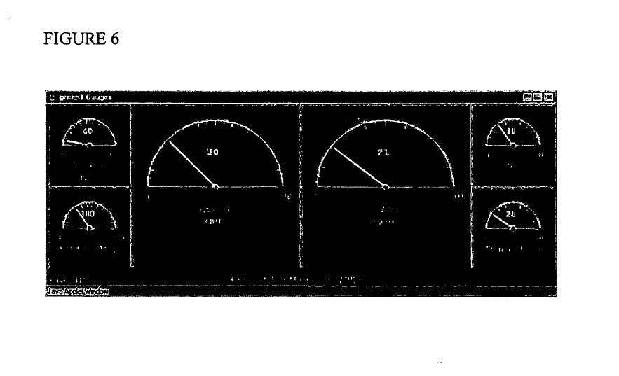

The Java applet was developed to display the tracking and performance information to the public via the Internet. The applet displays vehicle location on a digital map. Route information about the vehicles, in this case the campus bus system, is also available. When a bus is selected the user can view the current vehicle gauge data via graphical gauges such as in FIG. 6. This implementation allows the public to track a bus of interest, and fleet managers to monitor bus performance.

In the present system, by exploiting GPS technology, vehicle location can be pinpointed to within a couple of meters. An in-vehicle standard for diagnostic information, ODB-II, is used to gather performance data. Using a GSM/GPRS modem, the location and diagnostic information can be made available to a remote site via the Internet. Data is integrated and transmitted to a web server using Apache's Tomcat extensions to provide Internet access via a vehicle tracking web site. The present system design has an open architecture that can be easily expanded to other applications.

The relevant contents of each of the following references are hereby incorporated by reference, the same as if set forth at length.

(1) L. Figueiredo, I. Jesus, J. A. T. Machado, J. R. Ferreira, J. L. Martins de Carvalho, Towards the Development of Intelligent Transportation Systems. IEEE Intelligent Transportation Systems Proceedings, Oakland, Calif., 2001, 25-29.

(2) J. Cai, D. Goodman, General Packet Radio in GSM, IEEE Communications Magazine, 35(10), 1997, pp 122-131.

(3) S. Godavarty, S. Broyles and M. Parten, “Interfacing to the On-board Diagnostic System,” Proceedings Vehicular Technology Conference Vol. 4, pp. 2000-2004, 24-28, Sep. 2000.

(4) T. Yunck, G. Lindal, C. Liu, The role of GPS in precise Earth observation Position Location and Navigation Symposium, December 1988, 251-258.

(5) J. Brittain, I. F. Darwin, Tomcat: the definitive guide (O'Reilly, 2003).

(6) OnStar. (online). Available: http://www.onstar.com/us_english/jsp/index.jsp

(7) First Responders. (online). Available: http://www.northcom.mil/index.cfm?fuseaction=s.firstresponders.

(8) A. Wahab, T. Chong, N. Wah, O. Eng, W. Keong, A Low-Cost Yet Accurate Approach to a Vehicle Location Tracking System, IEEE ICICS, Singapore, 1997, pp 461-465.

(9) Garmin. “What is GPS.” (online). Available: http://www.garmin.com/aboutGPS/index.html

(10) GSMWorld. (online). Available: http://www.gsmworld.com/technology/faq.shtml

(11) S. Ni, GPRS Network Planning on the Existing GSM System, IEEE GLOBECOM, November-1 Dec. 2000, pp 1432-1438.

(12) SAE J 1850 May 2001, Class B Data Communication Network Interface, 2004 SAE Handbook, SAE international, 2004.

(13) SAE J 1962 April 2002, Diagnostic Connector Equivalent to ISO/DIS 15031-3: Dec. 14, 2001, 2004 SAE Handbook, SAE international, 2004.

(14) SAE J 1979 April 2002, E/E Diagnostic Test Modes Equivalent to ISO/DIS 15031: Apr. 30, 2002, 2004 SAE Handbook, SAE international, 2004.

(15) NMEA 0183 Standard for Interfacing Marine Electronic Devices, Version 2.0, National Marine Electronics Association, Mobile, Ala., January 1992.

(16) SAE J 1708 October 1993, Serial Communications Between Microcomputer Systems in Heavy-Duty Vehicle Applications, 2004 SAE Handbook, SAE international, 2004.

(17) SAE J 1939, Recommended Practice for a Serial Control and Communications Vehicle Network, SAE J1939 Standards Collection, SAE international, 2004.

(18) C. R. Boyce, A four station controller area network IEE Colloquium on Vehicle Networks for Multiplexing and Data Communication, December 1988, pp 9/1-9/7.

(19) K. English, L. Feaster, Community geography: GIS in action (ESRI Press, 2003).

(20) MARIS. (online). Available: http://www.maris.state.ms.us/index.html.

1. A real time vehicle communications system, comprising:
an interface unit configured to communicate with an onboard vehicle performance system and an onboard vehicle positioning system;
a processor unit connected to the interface unit;
a memory unit connected to the processor unit;
a communications unit connected to the processor unit, the communications unit being configured for wireless communication;
wherein the processor unit is configured to:
store data from the vehicle positioning system and the vehicle performance system in the memory unit, and
transmit at least some information from the memory unit, via the communications unit, to:
one or more peer vehicles outside the vehicle under the direction of a user; and
one or more base stations outside the vehicle.

2. The system of claim 1, further comprising a display unit connected to the communications unit, and wherein the processor unit is further configured to transmit said information to the display unit via the communications unit.

3. The system of claim 2, wherein the memory unit further comprises a map database stored thereon, and wherein the processor unit is further configured to generate a visual map on said display unit, wherein the map indicates a location of the vehicle.

4. The system of claim 2, wherein the processor unit is further configured to generate a graphical representation of the vehicle dashboard on said display unit, wherein the dashboard reflects information from the onboard vehicle performance system.

5. The system of claim 1, wherein the communications unit is further configured to act as an access point for at least one user device, wherein the access point connects the user device with a wireless network outside the vehicle.

6. The system of claim 1, wherein the access point communicates with the user device via a wireless or wired connection.

7. The system of claim 1, wherein the user device is selected from the group consisting of laptop computer, PDA, cell phone, networking device, or a combination thereof.

8. The system of claim 1, wherein the interface unit is further configured to communicate with at least one onboard sensor not in communication with the onboard vehicle performance system.

9. The system of claim 1, wherein the user is onboard the vehicle.

10. The system of claim 1, wherein the processor unit is further configured to receive information from the one or more peer vehicles.

11. The system of claim 10, further comprising a display unit connected to the communications unit, and wherein the processor unit is further configured to transmit, to the display unit, the information received from the one or more peer vehicles via the communications unit.

12. The system of claim 1, wherein communication with the one or more peer vehicles is conducted using public key cryptography.

13. A real-time vehicle position and performance monitoring system, comprising:
at least one vehicle communications system of claim 1;
a central server in communication with said vehicle communications system, said central server comprising:
at least one central vehicle position database, and
at least one central vehicle performance database; and
at least one web-based data visualization system in communication with the central server.

14. The system of claim 13, wherein the central server communicates with said vehicle communications system via at least network selected from the group consisting of wireless network, wired network, or a combination thereof.

15. The system of claim 13, wherein one or both of the central vehicle position database and the central vehicle performance database are outside a vehicle on which the vehicle communications system is installed.

16. The system of claim 13, wherein said web-based data visualization system comprises a map database and is configured to generate a visual map on a display, wherein the map indicates a location of a vehicle on which the at least one vehicle communications system is installed.

17. The system of claim 13, wherein said web-based data visualization system is configured to display information from the central vehicle performance database or the vehicle central vehicle position database or both.

18. The system of claim 13, wherein said web-based data visualization system is configured to generate, on a display, a graphical representation of a dashboard of a vehicle on which the at least one vehicle communications system is installed, wherein the dashboard reflects information from the central vehicle performance database.

19. A method real time vehicle communications comprising the steps of:
receiving vehicle performance data from an onboard vehicle performance system and vehicle position data from an onboard vehicle positioning system;
storing at least a portion of vehicle performance data and/or at least a portion of the vehicle position data in a memory unit;
transmitting a first portion of information from the memory unit to one or more base stations outside the vehicle; and
transmitting a second portion of information from the memory unit to one or more peer vehicles outside the vehicle under the direction of a user.

20. The method of claim 20, wherein the first and second portion are not the same.
